(19) United States
(12) Patent Application Publication
(10) Pub. No.: US 2009/0295568 A1
(43) Pub. Date: Dec. 3, 2009

(54) Systems and methods for wirelessly paging valet personnel

(76) Inventor: Ala Jamchi, San Diego, CA (US)

Correspondence Address: M. Reza Savari, Esq., 7668 Frederiksen Lane, Dublin, CA, 94568, US

(21) Appl. No.: 12/156,541

(22) Filed: Jun. 2, 2008

(51) Int. Cl. H04Q 7/00

(52) U.S. Cl. 340/539.11

(57) ABSTRACT

The present invention relates generally to the field of paging systems for alerting valet personnel to ready a car for pickup, and particularly to systems and methods allowing the owner of a car to wirelessly page the valet personnel to ready the car for pickup. The present invention is particularly adaptable for use by any valet parking service provider or by drivers who desire to utilize valet parking services. The systems and methods of the present invention allows the valet personnel to be alerted in advance of a customer's arrival, and provides for a window of time for the valet personnel to begin the process of readying the customer's car for pickup before the customer has even arrived at the valet parking's location.

### FIELD OF INVENTION

The present invention relates generally to the field of paging systems for alerting valet personnel to ready a car for pickup, and particularly to systems and methods allowing the owner of a car to wirelessly page the valet personnel to ready the car for pickup.

### BACKGROUND OF THE INVENTION

Valet parking is a popular parking service offered by some restaurants, stores, and other businesses for their customers in areas where parking spaces are not readily available for drivers. Instead of finding parking on their own, customers can have their car parked for them by a person called a valet.

Typically, the customer drops the car with the valet who gives a ticket in return to the customer at the time of drop. When the customer is ready to pick up the car, the driver presents the ticket to the valet who identifies the car and brings back the customer's car. Customers who use valet parking at popular or busy areas or establishments often have to wait a long time from the time they present the ticket to the valet to the time when the valet identifies the car and brings it back to the customer. Valet parking service providers attempt to maximize the use of space for parking by parking more cars into the same space by what is generally known as stack-parking. This is one of the reasons that the valet holds all the keys and is able to park the cars two or more deep, because the valet personnel can move cars out of the way to free a blocked-in car.

A variety of organizational and computer systems have been utilized by valet parking service providers in order to make the valet parking experience faster and more efficient. One of the most time consuming step with valet parking remains in the time spend for valet personnel to retrieve and return the car to the customer from the point the customer gives the ticket to the personnel to ready the car for pickup. While there has been a trend to identify a particular car for pickup and have sufficient valet personnel on duty to make valet parking more efficient, further improvements in the efficiency of valet parking and the speed of returning the car to the customer of valet perking is desirable, and the systems and methods for wireless paging of valet personnel of the present invention addresses the existing problems and provides related solutions and benefits.

### SUMMARY OF THE INVENTION

The present invention relates generally to the field of paging systems for alerting valet personnel to ready a car for pickup, and particularly to systems and methods allowing the owner of a car to wirelessly page the valet personnel to ready the car for pickup. The present invention is particularly adaptable for use by any valet parking service provider or by drivers who desire to utilize valet parking services. The systems and methods of the present invention allows the valet personnel to be alerted in advance of a customer's arrival, and provides for a window of time for the valet personnel to begin the process of readying the customer's car for pickup before the customer has even arrived at the valet parking's location.

The present invention recognizes that valet parking, and in particular readying a costumer's car for pickup can be made easier and in a more timely manner by providing a wireless paging system to the driver so that the driver can page and alert the valet personnel ahead of time and before the customer's arrival to the valet parking lot for the valet personnel to ready the car for pickup.

A first aspect of the present invention includes a car key system for wireless paging valet personnel, including a car key having a bow and a key bade, the bow including a transmitter portion releasably attached to a receiving portion, wherein the receiving portion of the bow is fixedly attached the key blade, the transmitter portion including a signal transmitter being capable of transmitting a certain unique signal upon activation, and the receiving portion including a signal receiver capable of receiving the certain unique signal from the transmitter portion, and indicating means for indicating that a signal was received from the transmitter portion; whereby a driver keeps the transmitter portion of the car key and leaves the receiving portion of the car key with the valet personnel, such that when the driver is ready to pick up the car, the driver activates the transmitter portion alerting the valet personnel to ready the car for pickup.

A second aspect of the present invention includes a wireless system for paging valet personnel, including a plurality of remote transmitters, each given to a different driver by valet personnel at the time of car drop-off; each of the remote transmitters being selectively activatable to request the valet personnel to ready the car for pickup, each remote transmitter being capable of transmitting a certain unique signal upon activation; and a central unit including a receiver which receives the signals from the remote transmitters, the central unit including indicating means for indicating that a signal was received from a particular remote transmitter; whereby when the driver is ready to pick up the car, the driver activates the remote transmitter alerting the valet personnel to ready the car for pickup.

A third aspect of the present invention includes a method for wireless paging of valet personnel, including a) providing a remote transmitter to a driver at the time of car drop-off, the remote transmitter being capable of transmitting a certain unique signal upon activation; and b) providing a receiver to the valet personnel, the receiver being capable of receiving the certain unique signal from the remote transmitter, the receiver including indicating means for indicating that a signal was received from a particular remote transmitter; whereby when the driver is ready to pick up the car, the driver activates the remote transmitter alerting the valet personnel to ready the car for pickup.

### BRIEF DESCRIPTION OF THE DRAWINGS

FIG. 1 shows a block diagram of the embodiment of the car key system for wireless paging valet personnel of the present invention.

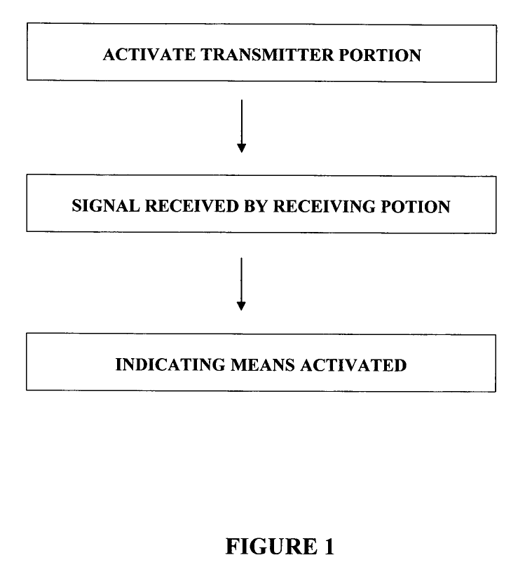

FIG. 2 shows a block diagram of the embodiment of the wireless system for paging valet personnel of the present invention.

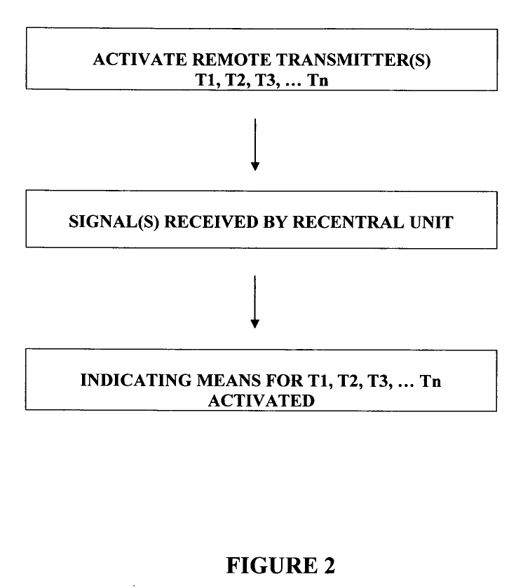

### DETAILED DESCRIPTION OF THE INVENTION

### Introduction

The present invention recognizes that valet parking, and in particular readying a costumer's car for pickup can be made easier and in a more timely manner by providing a wireless paging system to the driver so that the driver can page and alert the valet personnel ahead of time and before the customer's arrival to the valet parking lot for the valet personnel to ready the car for pickup.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention. Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

### I. Car Key System for Wireless Paging Valet Personnel

One embodiment of the present invention includes a car key system for wireless paging valet personnel, including a car key having a bow and a key bade. A car key can open the doors, as well as start the ignition, open the glove compartment and also open the trunk of the car. Some modern car keys also provide for remote locking of the doors and activation/deactivation of the alarm system. The present invention can be included with car by the car manufacturer, or the owners of a car that does not come with the car key of the present invention can have a car key of the present invention made to fit their cars.

In the present invention, the bow of the car key includes a transmitter portion releasably attached to a receiving portion, wherein the receiving portion of the bow is fixedly attached the key blade. This two piece configuration of the car key allows the driver to keep the transmitter portion of the car key when the car is dropped at a valet parking, and leave the receiving portion of the car key which is connected to the blade of the car key with the valet personnel. The transmitter portion and the receiving portion of the present invention can include a number of required or optional elements for proper functioning of the present invention, such as batteries, speakers, light emitting diodes, motors, radio antenna coil, microprocessors, and proper housing for all of the various elements. The transmitter portion and the receiving portion can be releasably attached to one another by way of quick-release locking mechanism, for example by way of snap-lock type mechanisms. Other types of releasable attaching means may also be utilized such as male/female type attachments, lock and key type attachments, adhesive type attachments, or any other suitable releasable attaching means.

The transmitter portion of the car key includes a signal transmitter that is capable of transmitting a certain unique signal upon activation, and the receiving portion of the car key includes a signal receiver capable of receiving the certain unique signal from the transmitter portion, and indicating means for indicating that a signal has been received from the transmitter portion. The transmitter of the present invention can be configured to transmit any suitable signal for its purpose, preferably the transmitter generates a radio signal which is transmitted by means of a suitable antenna. The transmitter portion can be configured to transmit an analogue or a digital signal having any desirable range, for example the transmitter can be capable of transmitting the signal from a few meters up to a few miles, preferably the transmitter is capable of transmitting the signal to up to one mile.

When a driver is ready to pick up the car, the driver can activate the transmitter portion of the car key ahead of arriving at the valet parking location and causing the indicating means to alert the valet personnel that the owner of the car will be arriving shortly to pick up the car. This system allows the valet personnel to prepare the car for pickup in a timely manner ahead of time, so that by the time the customer arrives at the valet parking location, the car is ready and little or no time needs to be wasted for the customer to wait for the car to be readied for pickup.

In the present invention, the indicating means of the receiving portion of the car key of the present invention may include one or more lights, or a display indicator, or a vibrator, or a buzzer, or a combination thereof. When the customer activates the transmitter of the car key sending a signal to the receiver, the receiver receives the signal and in response alerts the parking personnel by activating one or more audio and/or visual indicators representing that the a particular customer is on the way to pick up the car. Valet parking personnel generally attach a ticket stub to the key of customers and organize them by hanging each of the keys on a hook in their offices so that if a car needs to be moved, they can easily identify the key that corresponds with the car that is to be moved. The car key of the present invention will easily capture the attention of the valet parking personnel when activated in the valet parking office alerting the staff the a particular car needs to be prepared for pickup. The transmitter portion of the car key can include one or more options for transmitting various signals. For example, the customer may want the car to be readied within a particular time, or as soon as possible, and the customer can choose the type of signal to send that represents his desire for the timeframe. Different light indicators or vibration or buzzer modes can be used to convey the customer's desire time of pickup, or other indicating means can be a display that is able to display text or images that alert the parking personnel of the timeframe of the customer.

The transmitter portion of the car key of the present invention can include a child proof activating button, wherein the activating button has to be pressed for a period of time before the transmitter transmits the signal to the receiver. This safety feature can protect against accidental activation of the transmitter that will alert the valet personnel to prepare the car for pickup. For example, an accidental pressure placed upon the activating button will not activate the transmitter. Only a continuous pressure placed on the activating button, for example for about 3 to about 5 seconds, will ensure that a transmission of the signal has been truly intended by the customer. The transmitter portion can further include a timer so that the customer can set the timer and know how long the car has been parked.

The present invention may be further provided with means for locating the separable transmitter portion and the receiving portion in case one of the pieces is misplaced and cannot be easily found. For example, the separable pieces of the present invention may be provided with a transreceiver and an indicating means, such as a speaker, beeper, or a buzzer. In such configuration, the transmitter portion and the receiving portion include a locating means, wherein the transmitter portion and the receiving portion, each further include a transreceiver and an indicating means, wherein either transreceiver can be activated to send a signal to the other transreceiver, where the signal is received and the indicating means is activated in order to be located.

### II. Wireless System for Paging Valet Personnel

Another embodiment of the present invention includes a wireless system for paging valet personnel, including a plurality of remote transmitters, each given to a different driver by valet personnel at the time of car drop-off. The remote transmitters of the present invention may be similar in functionality to the transmitter portion of the Car Key System for Wireless Paging of Valet Personnel described above, but in different configuration suitable for its purpose. Each of the remote transmitters can be configure with the capability to be selectively activatable to request the valet personnel to ready the car for pickup, with each remote transmitter being capable of transmitting a certain unique signal upon activation.

The present invention includes a central unit including a receiver which receives the signals from the remote transmitters. The central unit includes indicating means for indicating that a signal was received from a particular remote transmitter. The indicating means of the central unit of the present invention may include one or more lights, or a display indicator, or a vibrator, or a buzzer, or a combination thereof. When the customer activates a particular remote transmitter, the receiver of the central unit receives the signal and in response activates the indicating means for that particular remote sensor which had sent the signal. The indicating means alert the parking personnel by activating one or more audio and/or visual indicators representing that the a particular customer is on the way to pick up the car. When the driver is ready to pick up the car, the driver activates the remote transmitter alerting the valet personnel to ready the car for pickup. The remote transmitters and the central unit including the receiver of the present invention can include a number of required or optional elements for proper functioning of the present invention, such as batteries, speakers, light emitting diodes, motors, radio antenna coil, microprocessors, and proper housing for all of the various elements.

The remote transmitters of the present invention can be configured to transmit any suitable signal for its purpose, preferably the remote transmitters generates a radio signal which is transmitted by means of a suitable antenna. The remote transmitters can be configured to transmit an analogue or a digital signal having any desirable range, for example the remote transmitters can be capable of transmitting the signal from a few meters up to a few miles, preferably the remote transmitters are capable of transmitting the signal to up to one mile.

The remote transmitters of the present invention can include a child proof activating button, wherein the activating button has to be pressed for a period of time before the remote transmitters transmit the signal to the receiver. This safety feature can protect against accidental activation of the remote transmitter that will alert the valet personnel to prepare the car for pickup. For example, an accidental pressure placed upon the activating button will not activate the transmitter. Only a continuous pressure placed on the activating button, for example for about 3 to about 5 seconds, will ensure that a transmission of the signal has been truly intended by the customer. The remote transmitters can further include a timer so that the customer can set the timer and know how long the car has been parked.

### III. Method for Wireless Paging Valet Personnel

Another embodiment of the present invention includes a method for wireless paging valet personnel, including providing a remote transmitter to a driver at the time of car drop-off, the remote transmitter being capable of transmitting a certain unique signal upon activation. The remote transmitter of the present invention may be similar in functionality to the transmitter portion of the Car Key System for Wireless Paging of Valet Personnel described above, but in different configuration suitable for its purpose. Each of the remote transmitters can be configure to be able to transmit a unique signal upon activation to request the valet personnel to ready the car for pickup, with each remote transmitter being capable of transmitting a certain unique signal upon activation.

The remote transmitter of the present invention can be configured to transmit any suitable signal for its purpose, preferably the remote transmitter generates a radio signal which is transmitted by means of a suitable antenna. The remote transmitter can be configured to transmit an analogue or a digital signal having any desirable range, for example the remote transmitter can be capable of transmitting the signal from a few meters up to a few miles, preferably the remote transmitter is capable of transmitting the signal to up to one mile.

The present invention includes providing a receiver to the valet personnel, the receiver being capable of receiving the certain unique signal from the remote transmitter the was provided to the driver. The receiver can include one or more indicating means for indicating that a signal was received from a particular remote transmitter. The receiver of the present invention includes indicating means for indicating that a signal was received from a particular remote transmitter. The indicating means of the present invention may include one or more lights, or a display indicator, or a vibrator, or a buzzer, or a combination thereof. When the customer activates a particular remote transmitter, the corresponding receiver receives the signal and in response activates the indicating means alerting the parking personnel by activating one or more audio and/or visual indicators representing that the a particular customer is on the way to pick up the car. When the driver is ready to pick up the car, the driver can activate the remote transmitter alerting the valet personnel to ready the car for pickup.

The remote transmitter and the receiver of the present invention can be configured into a car key comprising a bow and a key blade, wherein the bow includes the transmitter portion housing the remote transmitter and the receiving portion, wherein the transmitter portion can be releasably attached to the receiving portion housing the receiver, and wherein the receiving portion is fixedly attached to the key blade. The transmitter portion and the receiving portion can be releasably attached to one another by way of quick-release locking mechanism, for example by way of snap-lock type mechanisms. Other types of releasable attaching means may also be utilized such as male/female type attachments, lock and key type attachments, adhesive type attachments, or any other suitable releasable attaching means.

The transmitter portion of the car key of the present invention can include a child proof activating button, wherein the activating button has to be pressed for a period of time before the transmitter transmits the signal to the receiver. This safety feature can protect against accidental activation of the transmitter that will alert the valet personnel to prepare the car for pickup. For example, an accidental pressure placed upon the activating button will not activate the transmitter. Only a continuous pressure placed on the activating button, for example for about 3 to about 5 seconds, will ensure that a transmission of the signal has been truly intended by the customer. The transmitter portion can further include a timer so that the customer can set the timer and know how long the car has been parked.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims. Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. A car key system for wireless paging valet personnel, comprising:
a car key comprising a bow and a key bade, the bow comprising a transmitter portion releasably attached to a receiving portion, wherein the receiving portion of the bow is fixedly attached the key blade, the transmitter portion comprising a signal transmitter being capable of transmitting a certain unique signal upon activation, and the receiving portion comprising a signal receiver capable of receiving the certain unique signal from the transmitter portion, and indicating means for indicating that a signal was received from the transmitter portion;
whereby a driver keeps the transmitter portion of the car key and leaves the receiving portion of the car key with the valet personnel, such that when the driver is ready to pick up the car, the driver activates the transmitter portion alerting the valet personnel to ready the car for pickup.

2. The car key system of claim 1, wherein the indicating means of the receiving portion comprises one or more lights, or a display indicator, or a vibrator, or a buzzer, or a combination thereof.

3. The car key system of claim 1, where in the transmitter portion comprises a child proof activating button, wherein the activating button has to be pressed for a period of time before the transmitter transmits the signal.

4. The car key system of claim 3, wherein the period of time is 5 seconds.

5. The car key system of claim 1, wherein the transmitter portion further comprises a timer.

6. The car key system of claim 1, wherein the transmitter portion transmits an analogue or a digital signal having a range of up to one mile.

7. The car key of claim 1, wherein the transmitter portion and the receiving portion are releasably attached to one another by way of quick-release locking mechanism.

8. The car key of claim 7, wherein the quick-release locking mechanism comprises snap-lock mechanism.

9. The car key of claim 1, wherein the transmitter portion and the receiving portion further comprise a locating means, wherein the transmitter portion and the receiving portion, each further comprise a transreceiver and an indicating means, wherein either transreceiver can be activated to send a signal to the other transreceiver, where the signal is received and the indicating means is activated in order to be located.

10. A wireless system for paging valet personnel, comprising:
a plurality of remote transmitters, each given to a different driver by valet personnel at the time of car drop-off; each of the remote transmitters being selectively activatable to request the valet personnel to ready the car for pickup, each remote transmitter being capable of transmitting a certain unique signal upon activation; and
a central unit comprising a receiver which receives the signals from the remote transmitters, the central unit comprising indicating means for indicating that a signal was received from a particular remote transmitter;
whereby when the driver is ready to pick up the car, the driver activates the remote transmitter alerting the valet personnel to ready the car for pickup.

11. The wireless system of claim 10, wherein the indicating means of the central unit comprises one or more lights, or a display indicator, or a vibrator, or a buzzer, or a combination thereof.

12. The wireless system of claim 10, wherein the transmitter portion transmits an analogue or a digital signal having a range of up to one mile.

13. A method for wireless paging valet personnel, comprising:
a) providing a remote transmitter to a driver at the time of car drop-off, the remote transmitter being capable of transmitting a certain unique signal upon activation; and
b) providing a receiver to the valet personnel, the receiver being capable of receiving the certain unique signal from the remote transmitter, the receiver comprising indicating means for indicating that a signal was received from a particular remote transmitter;
whereby when the driver is ready to pick up the car, the driver activates the remote transmitter alerting the valet personnel to ready the car for pickup.

14. The method of claim 13, wherein the remote transmitter and the receiver are configured into a car key comprising a bow and a key blade, wherein the bow comprises a transmitter portion and a receiving portion, the transmitter portion housing the remote transmitter, the transmitter portion being releasably attached to a receiving portion housing the receiver, wherein the receiving portion is fixedly attached to the key blade.

15. The method of claim 13, wherein the indicating means of the receiver comprises one or more lights, or a display indicator, or a vibrator, or a buzzer, or a combination thereof.

16. The method of claim 13, wherein the remote transmitter transmits an analogue or a digital signal having a range of up to one mile.

17. The method of claim 14, wherein the transmitter portion and the receiving portion are releasably attached to one another by way of quick-release locking mechanism.

18. The method of claim 17, wherein the quick-release locking mechanism comprises snap-lock mechanism.

19. The method of claim 13, where in the transmitter portion comprises a child proof activating button, wherein the activating button has to be pressed for a period of time before the transmitter transmits the signal.

20. The method of claim 19, wherein the period of time is 5 seconds.
